(19) United States
(12) Patent Application Publication
(10) Pub. No.: US 2015/0380183 A1
(43) Pub. Date: Dec. 31, 2015

(54) Current Control Device

(71) Applicant: Jui-Chieh Chiu, Taoyuan City (TW)

(72) Inventors: Jui-Chieh Chiu, Taoyuan City (TW); Yi-Jing Lin, Taoyuan City (TW)

(21) Appl. No.: 14/746,860

(22) Filed: Jun. 23, 2015

(30) Foreign Application Priority Data
Jun. 25, 2014 (TW) 103121847

(51) Int. Cl. H01H 9/54

(52) U.S. Cl. CPC H01H 9/54

(57) ABSTRACT

A current control device includes a power connection unit, a primary current control unit and a primary power supply unit. The primary current control unit is coupled between the power connection unit and the primary power supply unit to control whether electricity is conducted between the power connection unit and the primary power supply unit. The primary current control unit includes a primary power switch, a current detection element and a microprocessor. The current detection element is utilized to measure an operation current value transmitted from the power connection unit to the primary power supply unit and compares the operation current value to the operation current value. When the comparison result is abnormal, a countdown period starts. If the operation current value remains abnormal during the countdown period, the primary power switch is OFF to cut off electricity supplied from the power connection unit to the primary power supply unit.

### BACKGROUND OF THE INVENTION

1. Field of the Invention

The invention relates to a current control device, and more particularly, to a current control device which controls power supply to appliances by detecting an operation current status to prevent standby appliances from wasting energy.

2. Description of the Prior Art

Without disconnecting from a power source at a plug, an electrical appliance is in standby mode even if it is switched off, and a small current could pass to draw electric power. This needless waste not only increases utility costs to consumers but also releases substantial amounts of carbon dioxide, which is implicated in global warming. As there are hundreds of thousands of families having household appliances unplugged, standby power can be a significant contributor to electricity usage. Therefore, it is a common goal in the industry to solve the problem of standby power consumption.

TW patent application no. 098143628 provides an “energy saving socket” which reduces energy usage and can cut power to its socket module; however, there is no adjustable buffer interval and hence inconveniences users. TW patent application no. 099213855 presents an “intelligent energy saving plug” but again without adjustable buffer interval. According to an “electrical power management device” of TW patent application no. 098220768, both a voltage sensor and a current sensor are necessary to measure standby power consumption, which increases cost and difficulty. Similarly, a “power-saving plug” of TW patent application no. 098209298 requires an extra comparator circuit and costs more. In a “cut-off device for electrical equipment” of TW patent application no. 099117714, a startup unit turns on a power supply unit and a cut-off unit, thereby bringing inconveniences. In view of these drawbacks, a flexible circuit approach is expected to reduce development cost and raise possibility of implementation.

### SUMMARY OF THE INVENTION

An embodiment of the present invention discloses a current control device, comprising a power connection unit, a primary current control unit and a primary power supply unit; wherein the power connection unit is coupled to a power source; the primary power supply unit is coupled to an appliance; the primary current control unit is coupled in series between the power connection unit and the primary power supply unit in order to control whether electricity is conducted between the power connection unit and the primary power supply unit; wherein the primary current control unit comprises a primary power switch, a current detection element, a first drive element, a microprocessor and a reset element; wherein the primary power switch and the current detection element are coupled in series between the power connection unit and the primary power supply unit; when the current control device is operated for powering, the primary power switch is turned on to conduct electricity from the power connection unit to the primary power supply unit; the first drive element is controlled by the control signal from the microprocessor to instruct the primary power switch to be ON or OFF; the current detection element is disposed between the power connection unit and the primary power supply unit to measure an operation current value transmitted from the power connection unit to the primary power supply unit and to transmit a detection result to the microprocessor; the reset element is coupled to the microprocessor and able to trigger the microprocessor to turn the first drive element on when the primary power switch is OFF in order to turn on the primary power switch to conduct electricity from the power connection unit to the primary power supply unit; the microprocessor is able to control the first drive element according to the operation current value measured by the current detection element in order to turn on or off the primary power switch by means of the first drive element.

Another embodiment of the present invention discloses a current control device, comprising a power connection unit, a primary current control unit, a primary power supply unit and a power drive control unit; wherein the power connection unit is coupled to a power source; the primary power supply unit is coupled to an appliance; the primary current control unit is coupled in series between the power connection unit and the primary power supply unit in order to control whether electricity is conducted between the power connection unit and the primary power supply unit; the power drive control unit is coupled between the power connection unit and the primary current control unit to control whether the primary current control unit supplies electric energy or not; wherein the primary current control unit comprises a primary power switch, a current detection element, a first drive element and a microprocessor; wherein the primary power switch and the current detection element are coupled in series between the power connection unit and the primary power supply unit; when the current control device is operated for powering, the primary power switch is turned on to conduct electricity from the power connection unit to the primary power supply unit; the first drive element is controlled by the control signal from the microprocessor to instruct the primary power switch to be ON or OFF; the current detection element is disposed between the power connection unit and the primary power supply unit to measure an operation current value transmitted from the power connection unit to the primary power supply unit and to transmit a detection result to the microprocessor; the microprocessor is able to control the first drive element according to the operation current value measured by the current detection element in order to turn on or off the primary power switch by means of the first drive element; the power drive control unit comprises an operation power switch, a power source element, a second drive element and a trigger element; wherein the operation power switch is coupled between the power connection unit and the primary current control unit, the operation power switch is turned on when powering to conduct electricity from the power connection unit to the power source element; the power source element is able to adjust power specifications of the power connection unit to supply power of appropriate power specifications for the microprocessor; the second drive element is controlled by the microprocessor to turn the operation power switch on or off; the trigger element is able to conduct electricity from the power connection unit to the power source element; when the operation power switch is OFF, the power source element is able to supply power to the primary current control unit for resuming normal operation by operating the trigger element.

Another embodiment of the present invention discloses a current control device, comprising a power connection unit, a primary power supply unit, a primary power switch and a current detection element; wherein the power connection unit is coupled to a power source; the primary power supply unit is coupled to an appliance; the primary power switch and the current detection element is coupled in series between the power connection unit and the primary power supply unit; the current detection element is utilized to measure an operation current value transmitted from the power connection unit to the primary power supply unit; the primary power switch is turned on or off according to the operation current value transmitted from the power connection unit to the primary power supply unit; operation current passing through the primary power switch flows into the current detection element to serve as operation current of the current detection element in order to save energy by a current reuse approach.

Another embodiment of the present invention discloses a current control device, comprising a power connection unit, a primary power supply unit, a current detection element, a signal processing unit and a microprocessor unit; wherein the power connection unit is coupled to a power source; the primary power supply unit is coupled to an appliance; the primary power switch and the current detection element is coupled in series between the power connection unit and the primary power supply unit; the current detection element is utilized to measure an operation current value transmitted from the power connection unit to the primary power supply unit; the signal processing unit processes and delivers signals transmitted from the current detection element to the microprocessor unit; the microprocessor unit has a reference current value to be compared to the operation current value measured by the current detection element.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3C are schematic diagrams illustrating a current control device according to a first embodiment of the present invention.

FIGS. 4 and 5 are schematic diagrams illustrating a current control device according to a second embodiment of the present invention.

FIG. 6 is a schematic diagram illustrating a current control device especially adapted to a set of appliances according to a third embodiment of the present invention.

### DETAILED DESCRIPTION

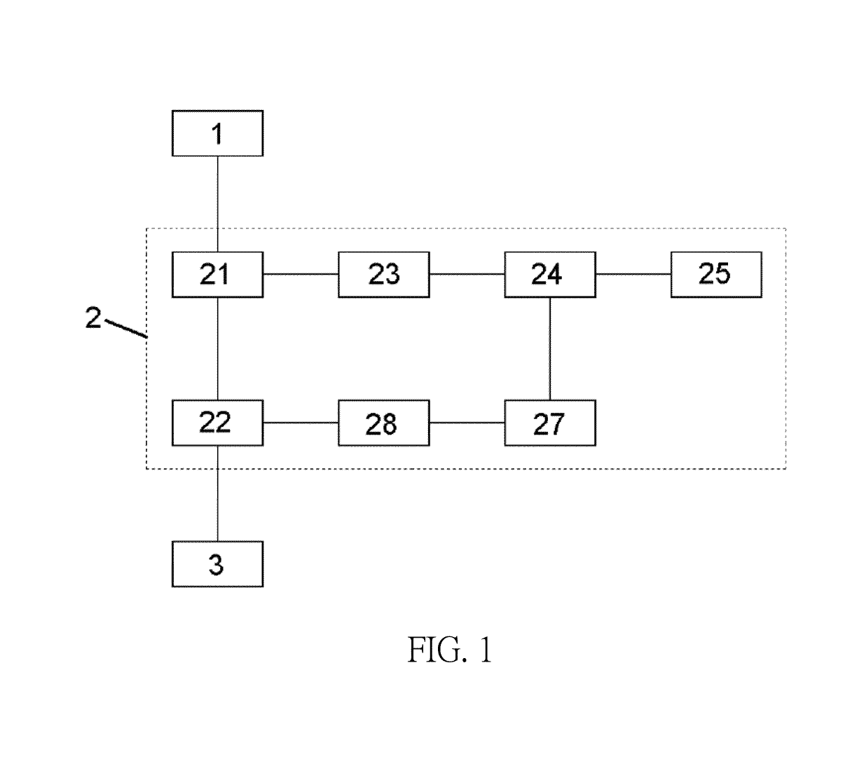

FIGS. 1-3C are schematic diagrams illustrating a current control device according to a first embodiment of the present invention. The current control device comprises a power connection unit 1, a primary current control unit 2 and a primary power supply unit 3. The power connection unit 1 can be connected to an external power source such as a 110/220 volt alternating current (AC) household power supply. The primary power supply unit 3 may be connected to a set of or more than one set of appliances. The primary current control unit 2 is electrically connected between the power connection unit 1 and the primary power supply unit 3 in order to control whether the primary power supply unit 3 supplies electric energy or not.

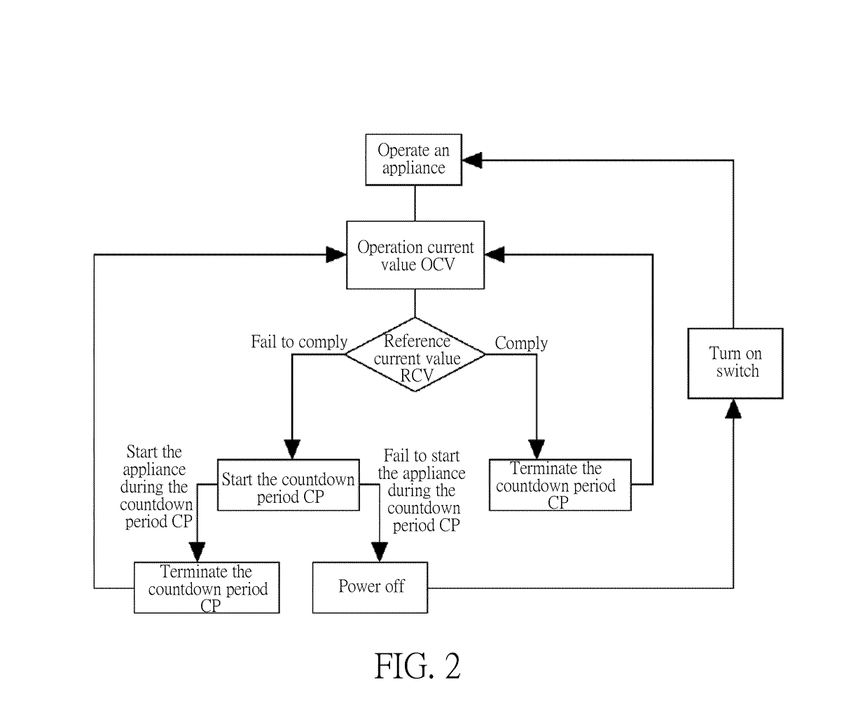

The primary current control unit 2 comprises a primary power switch 21, a current detection element 22, a first drive element 23, a microprocessor 24, a reset element 25, a signal amplifier element 27 and a filter element 28. The primary power switch 21 and the current detection element 22 are connected in series between the power connection unit 1 and the primary power supply unit 3. The primary power switch 21 is selected from, for example but not limited thereto, a relay and/or a triode for alternating current (TRIAC). The current detection element 22 is disposed between the power connection unit 1 and the primary power supply unit 3 to detect/measure an operation current value OCV of current flowing from the power connection unit 1 to the primary power supply unit 3, and to convert its detection result into a voltage signal, which is then transmitted to the microprocessor 24. The current detection element 22 is selected from a Hall Effect current sensor, a current transformer, a resistor element and/or a circuit or component capable of measuring current magnitude, but not limited herein. The signal amplifier element 27 is disposed between the current detection element 22 and the microprocessor 24 to amplify signals which are triggered and sent from the current detection element 22 and to subsequently deliver to the microprocessor 24. The filter element 28 disposed between the current detection element 22 and the microprocessor 24 is utilized to filter the signals which are triggered and transmitted from the current detection element 22 and to subsequently send to the microprocessor 24. The voltage signal, which is triggered by the detection results of the current detection element 22, may be supplied to the microprocessor 24 through the filter element 28 and the signal amplifier element 27 sequentially. On the other hand, the filter element 28 and the signal amplifier element 27 may be replaced by a rectifier element, which may be a filter, a diode, an Analog-to-digital converter (ADC), a detector circuit and/or a circuit or element able to convert spin-wave signals into stable signals; therefore, as the rectifier element is disposed between the current detection element 22 and the microprocessor 24, signals triggered and transmitted from the current detection element 22 may be converted into stable signals and then be provided to the microprocessor 24. The microprocessor 24 has a reference current value RCV, which may be predefined to a fixed value or a value range. The fixed value or the value range is in a range from the operation current value OCV (which is used when appliances turn on) to a standby current value SCV (which is used when appliances turn off), and may be compared to the voltage signal triggered by the current detection element 22. As shown in FIG. 2, when the operation current value OCV is determined to be higher or lower than the reference current value RCV, the microprocessor 24 starts a countdown period CP predefined. During the countdown period CP, if the operation current value OCV does not go back to the reference current value RCV—meaning that the appliance in use is continuously in an abnormal operation status—the microprocessor 24 forces the primary power switch 21 to be off by means of the first drive element 23 when the countdown period CP expires, such that electricity supply to the appliance in use is cut off to save power. The primary power switch 21 and the current detection element 22 are connected in series in terms of operation current; in other words, the operation current passing through the primary power switch 21 would flow into the current detection element 22 to serve as operation current of the current detection element 22, and this current reuse approach may save energy. In addition, the first drive element 23 may control the primary power switch 21 to be on or off, and the first drive element 23 is controlled by the voltage signal from the microprocessor 24. Therefore, the operation current shared by the primary power switch 21 and the current detection element 22 may be concurrently driven when the voltage signal from the microprocessor 24 controls the first drive element 23, which not only regulates current supply of the primary power supply unit 3 to appliances but also saves electricity.

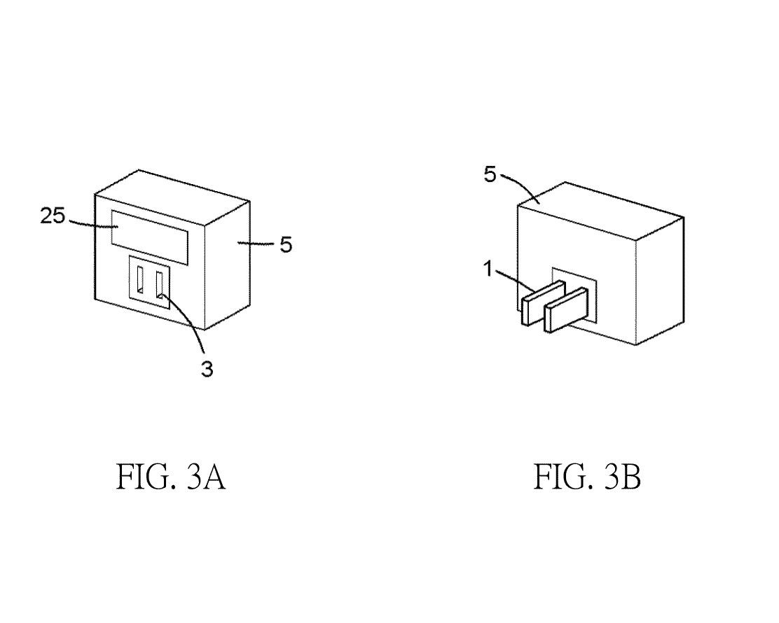

FIGS. 3A and 3B are schematic diagrams illustrating the structure of the current control device shown in FIG. 1 disposed in a housing 5 of an adaptor. The power connection unit 1 may be a plug disposed on the back of the housing 5. Obviously, the power connection unit 1 may also be an extension cord with a plug or a connector pin, but the present invention is not limited thereto and the power connection unit 1 may be any electrical connection element capable of connecting to the external power source. The primary power supply unit 3 is a socket disposed in the front of or at the side of the housing 5; alternatively, the primary power supply unit 3 may be a socket with an extension cord, or has a socket structure or a terminal block structure compatible with plugs of various appliances. The primary current control unit 2 are disposed inside the housing 5, and a button of the reset element 25 aforementioned is disposed in the front of the housing 5 and may be easily pressed to electrify the current control device when the current control device is initially turned on or restarted. FIG. 3C is a schematic diagram illustrating the structure of the current control device shown in FIG. 1 disposed in a Universal Serial Bus (USB). A first connector (e.g., a plug) of the USB serves as the power connection unit 1; a second connector (e.g., a receptacle) of the USB serves as the primary power supply unit 3. The primary current control unit 2 is disposed inside the housing 5 of the USB, and the button of the reset element 25 aforementioned is disposed in front of the housing 5.

To use the current control device, the plug of the power connection unit 1 is first inserted into a (wall-mounted) socket of the external power source for household electricity, and the power plug of an appliance to be used is then inserted into the socket of the primary power supply unit 3. When the button of the reset element 25 disposed on the housing 5 is pressed, the primary power switch 21 of the primary current control unit 2 is switched on and the appliance is powered on by the household electricity. When the appliance is powered, the current detection element 22 of the primary current control unit 2 would keep detecting and supervising the operation current value OCV of current in the power supply circuit, and outputs the voltage signal to the microprocessor 24 according to its detection result. As the appliance in use is turned off or in a standby mode with low electrical current, a comparison with the reference current value RCV predefined inside the microprocessor 24 is made. If the operation current value OCV is determined to be higher or lower than the reference current value RCV, the microprocessor 24 starts the countdown period CP predefined. As long as the appliance is restarted and/or used during the countdown period CP—meaning that the operation current value OCV reverts to the reference current value RCV—the countdown period CP is terminated, and the power supply circuit of the current control device maintains ON for the appliance to operate normally. On the other hand, if the appliance fails to be restarted and/or used even when the countdown period CP expires, the primary power switch 21 becomes OFF after the countdown period CP expires so as to cut off electricity supply for the appliance in use to save power. After that, the appliance may still be powered by household electricity again by pressing the button of the reset element 25 disposed on the housing 5. As set forth above, the present invention automatically/spontaneously breaks the connection between the external power source for household electricity and the appliance and thus stops the supply of electricity to the appliance when the appliance is not in use in order to prevent standby appliances from wasting energy.

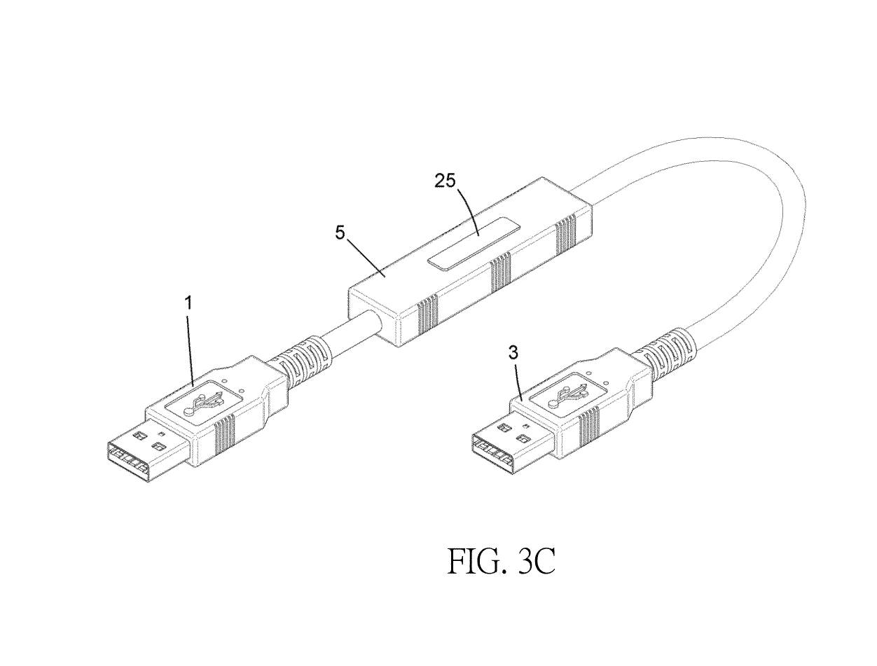

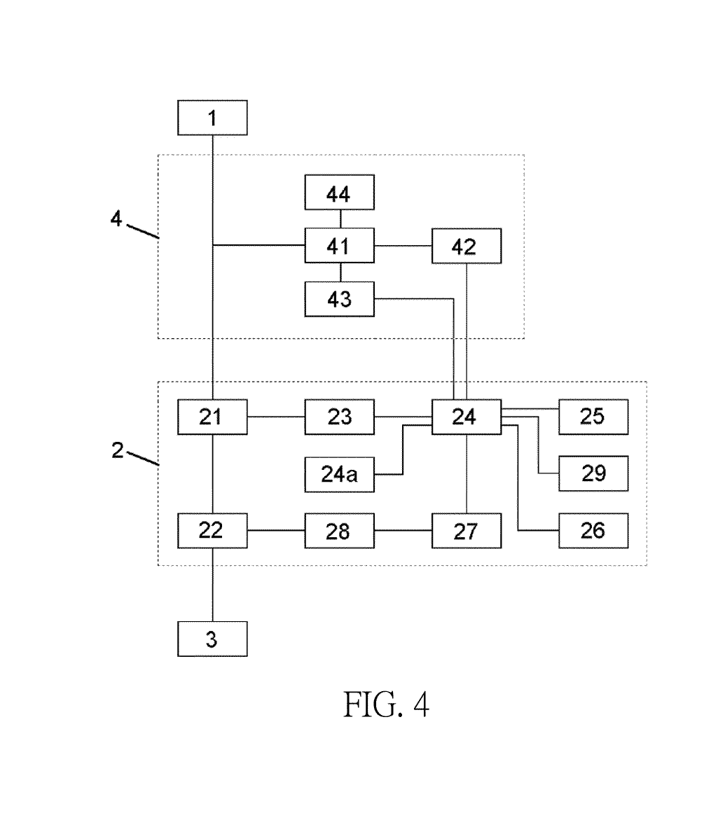

FIGS. 4 and 5 are schematic diagrams illustrating a current control device according to a second embodiment of the present invention. The current control device mainly comprises a power connection unit 1, a power drive control unit 4, a primary current control unit 2 and a primary power supply unit 3. The power connection unit 1 may be connected to an external power source such as a 110 volt AC household power supply. The primary power supply unit 3 may be connected to a set of or more than one set of appliances. The primary current control unit 2 is electrically connected between the power connection unit 1 and the primary power supply unit 3 in order to control whether the primary power supply unit 3 supplies electric energy or not. The power drive control unit 4 is electrically connected between the power connection unit 1 and the primary current control unit 2 so as to control whether the primary current control unit 2 supplies electric energy or not.

The primary current control unit 2 includes a primary power switch 21, a current detection element 22, a first drive element 23, a microprocessor 24, a configuration refinement element 24a, a reset element 25, a communication element 26, a signal amplifier element 27, a filter element 28 and a display element 29. The element structure and arrangement of the primary current control unit 2 in the second embodiment are substantially similar to that in the first embodiment, and the identical features will not be redundantly described. The primary power switch 21 and the current detection element 22 are connected in series between the power connection unit 1 and the primary power supply unit 3 mentioned above. The current detection element 22 is disposed between the primary power switch 21 and the primary power supply unit 3 to detect the operation current value OCV of current flowing from the power connection unit 1 to the primary power supply unit 3. The voltage signal triggered by the current detection element 22 is supplied to the microprocessor 24 after processed by the filter element 28 and the signal amplifier element 27 sequentially. The microprocessor 24 has the reference current value RCV predefined which may be compared to the voltage signal triggered by the current detection element 22. According to the comparison result, the microprocessor 24 may instruct the first drive element 23 to control the primary power switch 21 to be OFF or ON. The configuration refinement element 24a connected to the microprocessor 24 is utilized to change or configure default value of the countdown period CP and the reference current value RCV preset of the microprocessor 24, such that a user can set different operation parameters according to scenario and appliance type. The communication element 26 is selected from wireless communication modules (such as Wi-Fi, Bluetooth, Zigbee and infrared modules) or wired communication modules (for example, power line communication (PLC) network and network lines), but the type of communication modules is not limited thereto. The communication element 26 connected to the microprocessor 24 may receive control signal sent by the user externally and accordingly control or modify internal settings of the microprocessor 24—for example, directly starting up or turning off the primary power switch 21, and/or changing the reference current value RCV predefined or the default value of the countdown period CP. The display element 29 is connected to the microprocessor 24, and may present the related operation parameters and operation information of the current control device to increase ease in accessibility for the user. The display element 29 is selected from a liquid crystal display (LCD), a light emitting diode (LED) display panel and other types of display elements, but the type is not so limited.

The power drive control unit 4 comprises an operation power switch 41, a power source element 42, a second drive element 43 and a trigger element 44. The operation power switch 41 is connected in series between the power connection unit 1 and the primary current control unit 2. The operation power switch 41 is selected from, for example but not limited thereto, a relay and/or a TRIAC. The power source element 42 connected in series to the operation power switch 41 may adjust power specifications of the external power source aforementioned and supply power of appropriate power specifications for the microprocessor 24 to use. The power source element 42 may be selected from a transformer, a rectifier, a capacitor and/or a voltage regulator diode, but not limited thereto.

FIG. 5 is a schematic diagram illustrating the structure of the current control device shown in FIG. 4 disposed in the housing 5 of an adaptor. The power connection unit 1 may be a plug disposed on the back of the housing 5. The primary power supply unit 3 is a socket disposed in the front of or at the side of the housing 5. The primary current control unit 2 and the power drive control unit 4 are disposed inside the housing 5, and buttons of the reset element 25, the trigger element 44, the configuration refinement element 24a and the display element 29 are disposed in the front of the housing 5 for ease of use. A signal receiver section of the communication element 26 is also dispose on the surface (but not limited to the front surface) of the housing 5 to facilitate signal reception.

To use the current control device in the second embodiment, the plug of the power connection unit 1 is first inserted into the socket of the external power source for household electricity, and the power plug of an appliance to be used is then inserted into the socket of the primary power supply unit 3. When the button of the reset element 25 disposed on the housing 5 is pressed, the primary power switch 21 of the primary current control unit 2 is switched on and the appliance is powered on by the household electricity. When the appliance is powered, the current detection element 22 of the primary current control unit 2 would keep detecting and supervising the operation current value OCV of current in the power supply circuit, and outputs the voltage signal to the microprocessor 24 according to its detection result. As the appliance in use is turned off or in a standby mode with low electrical current, and alternatively as current abnormally go beyond the current assessment scope, a comparison with the reference current value RCV predefined inside the microprocessor 24 is made. If the operation current value OCV is determined to be lower than the reference current value RCV, the microprocessor 24 starts the countdown period CP predefined. As long as the appliance is restarted and/or used during the countdown period CP—meaning that the operation current value OCV becomes higher than the reference current value RCV—the countdown period CP is terminated, and the power supply circuit of the current control device maintains ON for the appliance to operate normally. On the other hand, if the appliance fails to be restarted and/or used even when the countdown period CP expires, the primary power switch 21 becomes OFF after the countdown period CP expires so as to cut off electricity supply for the appliance in use to save power. After that, the appliance may be powered by household electricity again by pressing the button of the reset element 25 disposed on the housing 5. In addition, a user may make modification according to different needs. For example, when the primary power switch 21 is turned off, the microprocessor 24 may simultaneously turn the operation power switch 41 off to save power. Alternatively, when the primary power switch 21 is turned off, the microprocessor 24 forces the operation power switch 41 to be ON in order to maintain power supply for the microprocessor 24, the communication element 26 and/or external circuits and in order to receive external control signal for restarting the primary power switch 21.

Apparently, operation of the second embodiment is similar to that of the first embodiment. However, unlike the first embodiment, the reference current value RCV predefined and the default value of the countdown period CP of the microprocessor 24 in the second embodiment may be adjusted and/or set by the configuration refinement element 24a. Moreover, the related operation parameters and operation information of the current control device are presented by the display element 29 to increase ease in accessibility for the user and to enhance utility. Furthermore, the current control device of the second embodiment requires fewer elements, costs less, works even for low current and may flexibly adjust buffer interval for shutting down appliances, thereby reducing cost and promoting efficiency of current management.

Besides, according to the second embodiment, when the primary current control unit 2 cuts off power supply to the appliance in use from household electricity, the microprocessor 24 forces the second drive element 43 of the power drive control unit 4 to turn the operation power switch 41 off, which makes the power source element 42 to stop supplying electric energy to the primary current control unit 2, in order to prevent the current control device in standby/idle mode from wasting electric energy itself further, thereby saving more electric energy. When the operation power switch 41 is turned off, the button of the trigger element 44 may be manually pressed to conduct electricity from the power connection unit 1 to the power source element 42, such that the power source element 42 may supply power to the microprocessor 24 and automatically control the operation power switch 41 to be turned on and self-locked. Accordingly, the power source element 42 supplies power to the primary current control unit 2 again, and it is easy to resume overall normal operation of the current control device. The user may make other modifications. For example, when the operation power switch 41 is turned ON and self-locked, the microprocessor 24 simultaneously turns the primary power switch 21 on in order to resume current conduction and to improve the accessibility and usability. The overall function of the current control device in the second embodiment may be further enhanced. Particularly, the microprocessor 24 may record data relevant to power consumption of an appliance in use, for example, the duration and the current to power on the appliance, the duration and the current of the appliance in standby mode, and the duration and the current to shut down the appliance. Then, the communication element 26 sends the recorded data of the appliance out, and a remote database would collect and make use of the recorded data to change the overall configuration of the current control device, thereby enhancing utility.

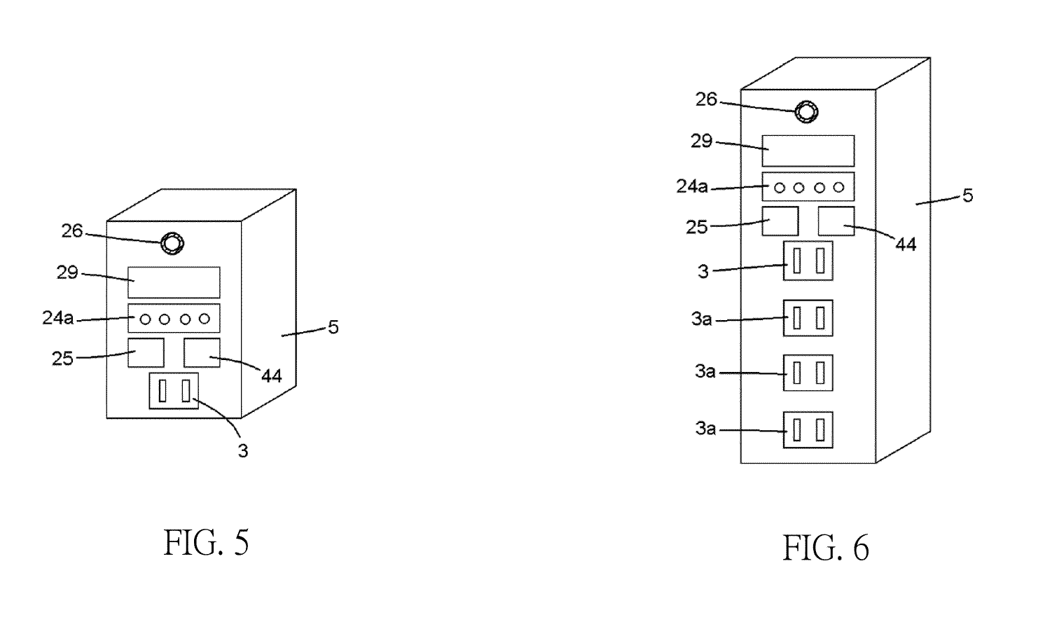

FIG. 6 is a schematic diagram illustrating a current control device especially adapted to a set of appliances according to a third embodiment of the present invention. The element structure and arrangement of the current control device in the third embodiment are substantially similar to that in the second embodiment; however, different from the second embodiment, the current control device in the third embodiment further comprises a plurality of secondary power supply units 3a apart from the primary power supply unit 3. Each of the secondary power supply units 3a and the primary power supply unit 3 are electrically connected to the primary power switch 21, and sockets of the primary power supply unit 3 and the secondary power supply units 3a are disposed in the front of or at the side of the housing 5. As the current control device in the third embodiment is utilized for a set of appliances such as a computer and its peripheral equipment, a plug of a power cord of the primary appliance (i.e., the computer) is inserted into the socket of the primary power supply unit 3, and plugs of a power cord of the peripheral equipment (e.g., a printer and a scanner) are inserted into the sockets of the secondary power supply units 3a respectively. By the same token, when the computer connected to the socket of the primary power supply unit 3 is turned off or in standby mode, the primary current control unit 2 counts down the number of seconds that remain before the countdown period CP predefined for powering off expires. If the computer fails to be restarted and/or used during the countdown period CP, the primary current control unit 2 cuts off electricity supply to the sockets of the primary power supply unit 3 and the secondary power supply units 3a after the countdown period CP expires to turn the computer and its peripheral equipment completely off, thereby avoiding power consumption in standby mode.

The current control device of the above-mentioned embodiments are implemented in adapters; nevertheless, the primary current control unit 2 of the present invention in fact may be directly disposed in a power supply circuit of an appliance in use. When the appliance is not in use for a while and thus idles, power supply automatically stops to save electricity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current control device, comprising a power connection unit, a primary current control unit and a primary power supply unit; wherein the power connection unit is coupled to a power source; the primary power supply unit is coupled to an appliance; the primary current control unit is coupled in series between the power connection unit and the primary power supply unit in order to control whether electricity is conducted between the power connection unit and the primary power supply unit; wherein the primary current control unit comprises a primary power switch, a current detection element, a first drive element, a microprocessor and a reset element; wherein the primary power switch and the current detection element are coupled in series between the power connection unit and the primary power supply unit; when the current control device is operated for powering, the primary power switch is turned on to conduct electricity from the power connection unit to the primary power supply unit; the first drive element is controlled by the control signal from the microprocessor to instruct the primary power switch to be ON or OFF; the current detection element is disposed between the power connection unit and the primary power supply unit to measure an operation current value transmitted from the power connection unit to the primary power supply unit and to transmit a detection result to the microprocessor; the reset element is coupled to the microprocessor and able to trigger the microprocessor to turn the first drive element on when the primary power switch is OFF in order to turn on the primary power switch to conduct electricity from the power connection unit to the primary power supply unit; the microprocessor is able to control the first drive element according to the operation current value measured by the current detection element in order to turn on or off the primary power switch by means of the first drive element.

2. A current control device, comprising a power connection unit, a primary current control unit, a primary power supply unit and a power drive control unit; wherein the power connection unit is coupled to a power source; the primary power supply unit is coupled to an appliance; the primary current control unit is coupled in series between the power connection unit and the primary power supply unit in order to control whether electricity is conducted between the power connection unit and the primary power supply unit; the power drive control unit is coupled between the power connection unit and the primary current control unit to control whether the primary current control unit or the microprocessor supplies electric energy or not; wherein the primary current control unit comprises a primary power switch, a current detection element, a first drive element and a microprocessor; wherein the primary power switch and the current detection element are coupled in series between the power connection unit and the primary power supply unit; when the current control device is operated for powering, the primary power switch is turned on to conduct electricity from the power connection unit to the primary power supply unit; the first drive element is controlled by the control signal from the microprocessor to instruct the primary power switch to be ON or OFF; the current detection element is disposed between the power connection unit and the primary power supply unit to measure an operation current value transmitted from the power connection unit to the primary power supply unit and to transmit a detection result to the microprocessor; the microprocessor is able to control the first drive element according to the operation current value measured by the current detection element in order to turn on or off the primary power switch by means of the first drive element; the power drive control unit comprises an operation power switch, a power source element, a second drive element and a trigger element; wherein the operation power switch is coupled between the power connection unit and the primary current control unit, the operation power switch is turned on when powering to conduct electricity from the power connection unit to the power source element; the power source element is able to adjust power specifications of the power connection unit to supply power of appropriate power specifications for the microprocessor; the second drive element is controlled by the microprocessor to turn the operation power switch on or off; the trigger element is able to conduct electricity from the power connection unit to the power source element; when the operation power switch is OFF, the power source element is able to supply power to the primary current control unit for resuming normal operation by operating the trigger element.

3. The current control device according to claim 1, wherein the primary power switch and the current detection element of the primary current control unit are coupled in series between the power connection unit and the primary power supply unit so that operation current passing through the primary power switch flows into the current detection element to serve as operation current of the current detection element in order to save energy by a current reuse approach.

4. The current control device according to claim 1, wherein the microprocessor has a reference current value to be compared to the operation current value measured by the current detection element; wherein when the operation current value is determined to be higher or lower than the reference current value, the microprocessor starts a countdown period; wherein during the countdown period, if the operation current value remains higher or lower than the reference current value, the microprocessor controls the primary power switch to be OFF by means of the first drive element to cut off electricity supplied from the power connection unit to the primary power supply unit when the countdown period expires.

5. The current control device according to claim 4, wherein the reference current value is a fixed value and in a range from the operation current value used when the appliance is turned on to a standby current value used when the appliance is turned off.

6. The current control device according to claim 4, wherein the reference current value is a value range and in a range from the operation current value used when the appliance is turned on to a standby current value used when the appliance is turned off.

7. The current control device according to claim 1, wherein the current detection element is selected from a Hall Effect current sensor, a current transformer, a resistor element and a circuit or element capable of measuring current magnitude.

8. The current control device according to claim 1, wherein the primary current control unit further comprises a filter element disposed between the current detection element and the microprocessor to filter signals triggered from the current detection element and to transmit the signals to the microprocessor.

9. The current control device according to claim 1, wherein the primary current control unit further comprises a signal amplifier element disposed between the current detection element and the microprocessor to amplify signals triggered from the current detection element and to transmit the signals to the microprocessor.

10. The current control device according to claim 1, wherein the primary current control unit further comprises a rectifier element disposed between the current detection element and the microprocessor to convert signals triggered from the current detection element into stable signals and to transmit the stable signals to the microprocessor; wherein the rectifier element is selected from a filter, a diode, an Analog-to-digital converter (ADC), a detector circuit and a circuit or element able to convert spin-wave signals into stable signals.

11. The current control device according to claim 1, wherein the first drive element is selected from a transistor, a field-effect transistor (FET), a triode for alternating current (TRIAC), a complementary metal-oxide-semiconductor (CMOS), an optical coupler (OC) and a circuit or element able to turn on or off current or voltage.

12. The current control device according to claim 1, wherein the primary power switch is selected from a relay, a TRIAC and a circuit or element able to turn on or off current or voltage.

13. The current control device according to claim 1, wherein the reset element is selected from a mechanical switch, a button, a transistor, a TRIAC, an OC, a sensor circuit, and a wired or wireless remote control circuit.

14. The current control device according to claim 1, wherein the microprocessor is able to record data associated with the appliance in use more than once, the data comprises duration and current to power on the appliance, duration and current of the appliance in standby mode, and duration and current to shut down the appliance.

15. The current control device according to claim 1, wherein the primary current control unit further comprises a communication element, the communication element is selected from a wireless communication module and a wired communication module, the communication element is able to receive control signals sent by a user externally and control or modify internal settings of the microprocessor, or transmit data associated with the appliance in use recorded by the microprocessor to a remote database.

16. The current control device according to claim 1, wherein the microprocessor further comprises a configuration refinement element to change or configure default value of the countdown period and the reference current value preset of the microprocessor.

17. The current control device according to claim 2, wherein the trigger element is turned on to conduct electricity from the power connection unit to the power source element, the power source element supplies power to the microprocessor, the microprocessor turns on the second drive element and makes the operation power switch self-locked and ON.

18. The current control device according to claim 2, wherein the second drive element is selected from a transistor, a FET, a TRIAC, a CMOS, an OC and a circuit or element able to turn on or off current or voltage.

19. The current control device according to claim 2, wherein the operation power switch is selected from a relay, a TRIAC and a circuit or element able to turn on or off current or voltage.

20. The current control device according to claim 2, wherein the power source element is selected from a diode, a capacitor, a transformer, a resistance capacitance (RC) voltage-reducing circuit, a voltage regulator, a flyback converter and a circuit or element able to provide constant voltage or constant current.

21. The current control device according to claim 2, wherein the trigger element is selected from a mechanical switch, a button, a transistor, a TRIAC, an OC, a sensor circuit, and a wired or wireless remote control circuit.

22. A current control device, comprising a power connection unit, a primary power supply unit, a primary power switch and a current detection element; wherein the power connection unit is coupled to a power source; the primary power supply unit is coupled to an appliance; the primary power switch and the current detection element is coupled in series between the power connection unit and the primary power supply unit; the current detection element is utilized to measure an operation current value transmitted from the power connection unit to the primary power supply unit; the primary power switch is turned on or off according to the operation current value transmitted from the power connection unit to the primary power supply unit; operation current passing through the primary power switch flows into the current detection element to serve as operation current of the current detection element in order to save energy by a current reuse approach.

23. A current control device, comprising a power connection unit, a primary power supply unit, a current detection element, a signal processing unit and a microprocessor unit; wherein the power connection unit is coupled to a power source; the primary power supply unit is coupled to an appliance; the primary power switch and the current detection element is coupled in series between the power connection unit and the primary power supply unit; the current detection element is utilized to measure an operation current value transmitted from the power connection unit to the primary power supply unit; the signal processing unit processes and delivers signals transmitted from the current detection element to the microprocessor unit; the microprocessor unit has a reference current value to be compared to the operation current value measured by the current detection element.

24. The current control device according to claim 23, wherein the signal processing unit is a rectifier unit, wherein the rectifier element is selected from a filter, a diode, an ADC, a detector circuit and a circuit or element able to convert spin-wave signals into stable signals.

25. The current control device according to claim 23, wherein the signal processing unit is an active filter unit with a function of filtering noise out and signal amplification, the signal processing unit is selected from a circuit formed from resistors, capacitors or inductors, a filter circuit formed from amplifiers and a circuit with a function of filtering and amplification.

26. The current control device according to claim 2, wherein the primary power switch and the current detection element of the primary current control unit are coupled in series between the power connection unit and the primary power supply unit so that operation current passing through the primary power switch flows into the current detection element to serve as operation current of the current detection element in order to save energy by a current reuse approach.

27. The current control device according to claim 2, wherein the microprocessor has a reference current value to be compared to the operation current value measured by the current detection element; wherein when the operation current value is determined to be higher or lower than the reference current value, the microprocessor starts a countdown period; wherein during the countdown period, if the operation current value remains higher or lower than the reference current value, the microprocessor controls the primary power switch to be OFF by means of the first drive element to cutoff electricity supplied from the power connection unit to the primary power supply unit when the countdown period expires.

28. The current control device according to claim 27, wherein the reference current value is a fixed value and in a range from the operation current value used when the appliance is turned on to a standby current value used when the appliance is turned off.

29. The current control device according to claim 27, wherein the reference current value is a value range and in a range from the operation current value used when the appliance is turned on to a standby current value used when the appliance is turned off.

30. The current control device according to claim 2, wherein the current detection element is selected from a Hall Effect current sensor, a current transformer, a resistor element and a circuit or element capable of measuring current magnitude.

31. The current control device according to claim 2, wherein the primary current control unit further comprises a filter element disposed between the current detection element and the microprocessor to filter signals triggered from the current detection element and to transmit the signals to the microprocessor.

32. The current control device according to claim 2, wherein the primary current control unit further comprises a signal amplifier element disposed between the current detection element and the microprocessor to amplify signals triggered from the current detection element and to transmit the signals to the microprocessor.

33. The current control device according to claim 2, wherein the primary current control unit further comprises a rectifier element disposed between the current detection element and the microprocessor to convert signals triggered from the current detection element into stable signals and to transmit the stable signals to the microprocessor; wherein the rectifier element is selected from a filter, a diode, an Analog-to-digital converter (ADC), a detector circuit and a circuit or element able to convert spin-wave signals into stable signals.

34. The current control device according to claim 2, wherein the first drive element is selected from a transistor, a field-effect transistor (FET), a triode for alternating current (TRIAC), a complementary metal-oxide-semiconductor (CMOS), an optical coupler (OC) and a circuit or element able to turn on or off current or voltage.

35. The current control device according to claim 2, wherein the primary power switch is selected from a relay, a TRIAC and a circuit or element able to turn on or off current or voltage.

36. The current control device according to claim 2, wherein the microprocessor is able to record data associated with the appliance in use more than once, the data comprises duration and current to power on the appliance, duration and current of the appliance in standby mode, and duration and current to shut down the appliance.

37. The current control device according to claim 2, wherein the primary current control unit further comprises a communication element, the communication element is selected from a wireless communication module and a wired communication module, the communication element is able to receive control signals sent by a user externally and control or modify internal settings of the microprocessor, or transmit data associated with the appliance in use recorded by the microprocessor to a remote database.

38. The current control device according to claim 2, wherein the microprocessor further comprises a configuration refinement element to change or configure default value of the countdown period and the reference current value preset of the microprocessor.
